(19) United States
(12) Patent Application Publication
(10) Pub. No.: US 2022/0411006 A1
(43) Pub. Date: Dec. 29, 2022

(54) MOTORCYCLE WITH WIRELESS RECHARGE SYSTEM FOR RECHARGING ELECTRICALLY POWERED DEVICES PROVIDED IN MOTORCYCLE HELMETS

(71) Applicant: PIAGGIO & C. S.P.A., Pontedera (IT)

(72) Inventors: Mario SANTUCCI, Pontedera (IT); Luca SACCHI, Pontedera (IT); Luigi BARACCHINO, Pontedera (IT)

(21) Appl. No.: 17/778,237

(22) PCT Filed: Nov. 16, 2020
(86) PCT No.: PCT/IB2020/060752

§ 371 Date: May 19, 2022

(30) Foreign Application Priority Data
Nov. 20, 2019 (IT) 102019000021696

(51) Int. Cl. B62K 19/46; B62J 7/02; A42B 3/00; H02J 50/12; H02J 50/00

(52) U.S. Cl. CPC B62K 19/46; B62J 7/02; A42B 3/006; H02J 50/12; H02J 50/005

(57) ABSTRACT

A container for housing a motorcycle helmet, defining a compartment where the helmet can be arranged, characterized by comprising at least one wireless power transmitter that is associated with said compartment, that can be operatively connected to an electric power source and that is adapted to send electric charge to at least one wireless power receiver of an electric device provided with at least one rechargeable battery associated with said helmet, to recharge said battery during a step of wireless power recharge.

### TECHNICAL FIELD

The present invention relates to the field of motorcycles; more in particular, it relates to a motorcycle provided with a system for recharging electrically powered devices provided in motorcycle helmets.

A further object of the invention is a motorcycle helmet provided with an electrically powered device, usable with a motorcycle as mentioned above.

### STATE OF THE ART

As it is well known, motorcyclists wearing protective helmets often have the need for vocally interacting with other people. For this reason, for many years now many helmets have been provided with intercom devices, with which headphones and microphone are associated, allowing the motorcyclist to speak with, and to listen to, other people wearing a complementary device.

The intercom device allows for example a motorcyclist communicating with a passenger on the same motorcycle.

Recently, since when mobile phones have been widely used, the intercom device can be connected to the mobile phone, allowing the motorcyclist making phone calls.

The technology associated with the intercom device is the most varied. In general, the intercom device can be removed from the helmet to allow recharging the electric battery thereof.

When the motorcyclist does not use the helmet, he/she often leaves it on the motorcycle, inside a specific container that is typically the under-seat storage compartment or the top box on the back of the motorcycle.

The motorcyclist often forgets to release the intercom device from the helmet and to bring it home for recharging it; thus, it can occur that the charge level of the intercom device is very low or null when used again, and that the device cannot therefore operate.

### SUMMARY

The scope of the invention is to provide a system allowing the electric devices associated with the helmets being always charged when they shall be used.

Within this scope, an important object of the invention is to provide a motorcycle provided with a container for helmets, such as an under-seat compartment or a top box, which can be conveniently used with a system for recharging electric devices associated with the helmets and which is adapted to facilitate the recharging of these devices also when the helmets are housed in the container.

A further object of the invention is to provide a motorcycle helmet that can be conveniently used together with a helmet container, for example a under-seat compartment or a top box, within a system for recharging electrically powered devices.

A further object of the invention is to provide a system for recharging electrically powered devices associated with motorcycle helmets, that is particularly simple and easy to be used and implemented.

These and other objects, that will be better described below, are achieved through a motorcycle comprising:
a container for housing a motorcycle helmet, defining a compartment where the helmet can be arranged, the container further comprising at least one wireless power transmitter that is associated with the compartment, that can be operatively connected to a power source and that is adapted to send electric charge to at least one wireless power receiver of an electric device provided with at least one rechargeable battery associated with the helmet, to recharge the battery during a step of wireless power recharge,
an electric system that is, or can be, operatively connected to the at least one power transmitter of the container, the electric system being provided with a battery of the motorcycle and with an electronic control apparatus provided with the following controls:
control over the state of charge of the at least one battery of the at least one electric device of the helmet,
control over the state of charge of the motorcycle battery and stop of the charge of the battery of the helmet electric device if the charge level of the motorcycle battery is lower than a threshold value.

Therefore, once the helmet, adequately provided with the necessary power receiving components, has been arranged inside the motorcycle container, which can be for example an under-seat compartment or a top box, the container allows starting a step recharging the battery of an electric device provided in the helmet, such as an intercom device.

According to preferred embodiments, the motorcycle container comprises, on the inner surface defining the compartment, at least one surface area for power transmission; adequately, the at least one wireless power transmitter is provided in this surface area for power transmission, so that, considering a helmet comprising at least one electric device to be recharged and provided with at least one wireless power receiver arranged in a given portion of the helmet, when the helmet is housed in the compartment, the at least one wireless power receiver is operatively close to, and preferably aligned with, the at least one wireless power transmitter, thus allowing power transmission. In some embodiments, the at lest one surface area is concave so that, when the helmet is housed in the compartment, the surface area follows the convexity of the helmet portion provided with the at least one wireless power receiver; adequately, when the helmet is housed in the compartment, this helmet portion is in contact with, or very close to, the surface area of the compartment.

Preferably, the motorcycle container comprises a lid for closing the compartment, for example hinged to the part of the container structure defining the same compartment. The at least one wireless power transmitter is preferably provided on one or more of the following: the lid of the compartment, the bottom of the compartment, a side part of the compartment.

According to preferred embodiments, the at least one wireless power transmitter is of inductive coupling type, preferably of resonant type.

According to preferred embodiments, the at least one wireless power transmitter comprises at least one electric coil adapted to induce electric current. The electric coil is planar, preferably flat-shaped or curve-shaped.

According to preferred embodiments, the at least one wireless power transmitter comprises a plurality of electric coils adapted to induce electric current, arranged close to, and/or over, one another according to a preset scheme. In this case, the electronic control apparatus is adequately adapted to discriminate which coil of the wireless power transmitter is more aligned with a coil of the wireless power receiver associated with the helmet, so as to bring the current to this coil, thus maximizing the power transmission.

In preferred embodiments, the electronic control apparatus comprises a communication interface adapted to communicate the operator the charge level of the at least one battery of the at least one electric device of the helmet.

In preferred embodiments, the electronic control apparatus comprises a sensor adapted to discriminate whether the motorcycle is on or off, and
if the sensor detects that the motorcycle is on, the electronic control apparatus supplies the transmitter with electric current,
if the sensor detects that the motorcycle is off, the electronic control apparatus supplies the transmitter with electric current only if the charge level of the motorcycle battery is greater than a given threshold value.

According to preferred embodiments, the motorcycle container is in the form of top box, and comprises 1) a reversible fastening apparatus for fastening to a motorcycle, 2) a power connection device adapted to connect electrically the at least one wireless power transmitter to the battery of the motorcycle electric system.

According to preferred embodiments, the motorcycle container is provided in, or integrated into, the under-seat area and the motorcycle seat is part of a lid closing the compartment, and the at least one wireless power transmitter is operatively connected to the battery of the motorcycle electric system.

In preferred embodiments, the container comprises a device for coupling and/or fastening the at least one wireless power transmitter to the helmet shell, so that the at least one wireless power transmitter and the at least one wireless power receiver associated with the helmet are mutually coupled and/or fastened in a position that is optimal for power transmission.

The coupling and/or fastening device preferably provides for a reciprocal coupling and/or fastening of the transmitter and the helmet of the magnetic attraction type. This coupling and/or fastening device comprises, for example, one or more magnetic attraction first elements on the at least one wireless power transmitter and one or more magnetic attraction second elements on the at least one wireless power receiver (for example permanent magnets and corresponding ferromagnetic elements) or vice versa.

For instance, one or more permanent magnets, for example two or three, are provided on, or near, the at least one wireless power transmitter, whilst two or three ferromagnetic elements are provided on, or inside, the helmet shell, near, or on, the at least one wireless power receiver, in such a position that, when the helmet is housed in the container, the wireless power transmitter is in contact with the part of shell, and the ferromagnetic elements of the helmet are centered on the permanent magnets of the wireless power transmitter, so that receiver and transmitter are perfectly aligned or centered, thus optimizing power transmission.

With reference to the shell of the device for coupling and/or fastening the at least one wireless power transmitter to the helmet shell, in an embodiment the at least one wireless power transmitter is associated in non-rigid manner with the wall (side wall, bottom wall or lid) of the compartment of the container, so that, whilst the motorcycle moves, in case of accidental moving of the helmet away from the wall, the transmitter is able to follow the helmet, avoiding the release thereof.

In some embodiments, the motorcycle comprises a container under the seat, the seat can be overturned and forms at least part of the openable lid of the container compartment, and the at least one wireless power transmitter is operatively connected to the battery of the motorcycle electric system.

According to a further aspect, the invention also relates to a helmet for motorcycles according to one or more of the embodiments mentioned above, comprising an outer shell and a protection padding for the motorcyclist's head, comprising at least one electrically powered service device powered by at least one rechargeable battery, characterized by comprising a module for wireless power recharge of the at least one rechargeable battery, the power recharge module comprising at least one wireless power receiver adapted to receive electric charge from a wireless power transmitter during a power recharge step.

The at least one wireless power receiver is preferably arranged between the shell and the protection padding.

The at least one wireless power receiver is preferably arranged inside the concave compartment defined by the shell.

According to preferred embodiments, the at least one wireless power transmitter is arranged close to, or preferably in contact with, the inner face of the outer shell.

According to preferred embodiments, the electric recharge module comprises at least a first wireless power receiver and a second wireless power receiver, and a switching device adapted to disable, during a recharge step, at least one of the first and second wireless power receivers if the disabled power receiver is receiving power less efficiently than the other power receiver.

According to preferred embodiments, the at least one wireless power receiver is of inductive coupling type, preferably of resonant type.

According to preferred embodiments, the at least one wireless power receiver comprises at least one electric coil adapted to receive induced current.

The at least one battery is preferably comprised inside the structure of the helmet.

The at least one wireless power receiver is preferably spaced from the at least one battery.

According to preferred embodiments, the helmet comprises a lower area defining an end edge delimiting the area where the motorcyclist's head enters; the at least one battery is positioned in this lower area of the helmet; this lower area preferably comprises a band extending for approximately 10 cm from the end edge upwards; preferably, the at least one wireless power receiver is outside this lower area, i.e. it is provided on the upper area of the helmet.

According to preferred embodiments, the at least one electrically powered service device comprises one or more of the following apparatuses: intercom, headphones, microphone, interface with mobile communication device, apparatus for sending to a remote entity a notice if the motorcyclist falls, vocal apparatus for controlling one or more functions of the motorcycle.

According to a further aspect, the invention relates to a system for recharging electrically powered service devices provided in motorcycle helmets, comprising
a motorcycle with a container for helmet according to one or more of the preferred embodiments mentioned above,
a motorcycle helmet according to one or more of the preferred embodiments mentioned above.

According to a further aspect, the invention relates to a method for recharging an electric device associated with a helmet for motorcycles provided with electric battery, preferably according to one or more of the preferred embodiments mentioned above, providing for the following steps:
inserting the helmet inside a container defined in the under-seat compartment of a motorcycle or in a top box fastened to a motorcycle, and
transmitting electric power, through induction, from a wireless power transmitter provided in the container to at least one wireless power receiver provided on the helmet, which is operatively connected to an electric battery, allowing the recharge thereof,
before the power transmission step, verifying the charge level of the at least one battery of the at least one helmet's electric device and verifying the charge level of the motorcycle battery and, if the charge level of the motorcycle battery is below a given threshold level, stopping the electric power transmission from the wireless power transmitter to the wireless power receiver of the battery of the electric device of the helmet.

Preferably, the method provides for verifying, through a sensor, whether the motorcycle is off or on and, in case the motorcycle is on, supplying electric current from the motorcycle battery to the wireless power transmitter for recharging.

The method preferably provides for verifying, through a sensor, whether the motorcycle is off or on and, in case the motorcycle is off, supplying electric current from the motorcycle battery to the wireless power transmitter only when the charge level of the motorcycle battery is greater than a given threshold value.

### BRIEF DESCRIPTION OF THE DRAWING

The invention will be better understood by following the description below and the attached drawing, showing a non-limiting embodiment of the invention. More specifically, in the drawing:

FIG. 1 is a schematic view of a portion of motorcycle according to the invention, where the under-seat compartment is shown, containing two helmets, and a top box containing a third helmet;

FIG. 2 is a schematic view of the helmet of the invention, where a wireless power receiver is schematized, wired to an electric service device of the helmet;

each of FIGS. 3, 4 and 5 shows a schematic view of a portion of the compartment of the container of the invention, where a wireless power transmitter is show in different positions relative to the inner surface of the compartment;

FIG. 6 is a schematic view of a portion of compartment of the container according to the invention with a respective helmet portion inserted in the compartment, where two wireless power receivers associated with the helmet and a wireless power transmitter associated with the compartment are highlighted;

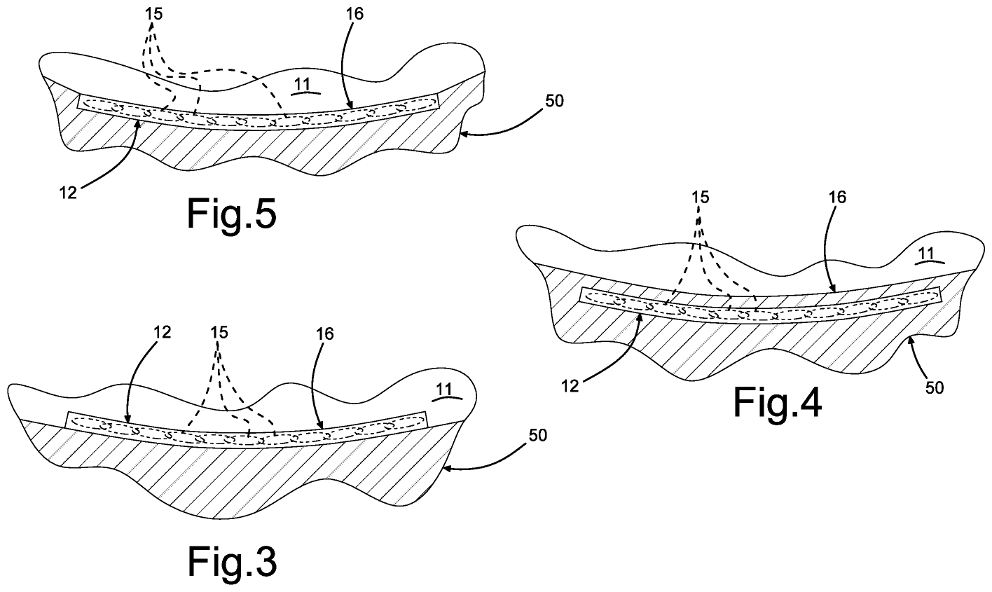

FIG. 7 shows a diagram of the recharge module of the helmet of the invention associated with the wireless power transmitter.

### DETAILED DESCRIPTION OF EMBODIMENTS

With reference to the figures listed above, a first container according to the invention for housing a motorcycle helmet is indicated as a whole with the reference number 10; it is provided, for instance, in the under-seat area of a motorcycle indicated as a whole with number 50.

In particular, the container 10 defines, under the seat 51 of the motorcycle 50, a compartment 11 adapted to contain, for instance, a pair of helmets 40.

The seat 51 can be overturned (harrow f), in a known manner, i.e. it is hinged in X to the structure of the motorcycle 50, and it allows opening or closing the compartment 11, forming in practice, in this example, the lid of the compartment 11, or anyway a part thereof.

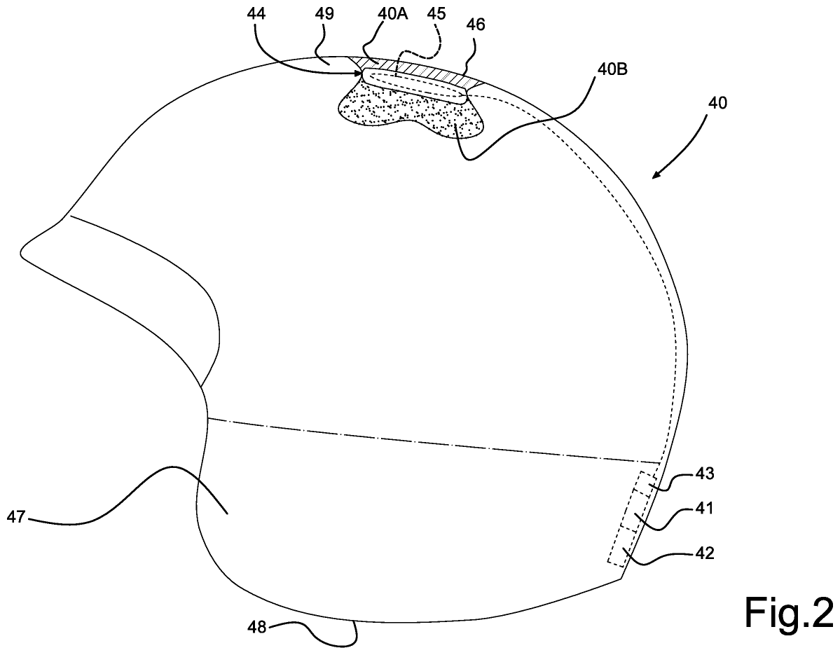

At least one wireless power transmitter 12 is associated with the compartment 11. The transmitter 12 is adapted to induce electric current in a wireless power receiver 44 of an electric device 41, associated with the helmet 40, and provided with a rechargeable electric battery 42 (see FIG. 2) to recharge the battery during a wireless recharge step, as better explained below.

In this example, the wireless power transmitter 12 is of inductive coupling type, more preferably of resonant type, and provides therefore for an adequate electric transmission circuit (known in se and not shown in the figures). Coherently, the wireless power receiver 44 of the helmet 40 is functionally complementary, i.e. it is of inductive resonant coupling type too. The receiving-transmitting components can be, for example, of known type, for example those developed by the companies of the WPC-Wireless Power Consortium, by the companies of the PMA-Power Matter Alliance, and the like.

The wireless power transmitter 12 is operatively connected to the electric system 52 of the motorcycle 50, and it is in particular operatively connected to the electric battery 53 powering the electric services of the motorcycle.

For example, the wireless power transmitter 12 comprises a plurality of electric coils 15, adapted to generate an electromagnetic field. The electric coils are planar, i.e. the windings thereof are mainly arranged according to a radial direction, not according to an axial direction. These planar electric coils are arranged close to one another, or partially over one another, according to a preset scheme. An example of this transmitter is disclosed in the patent document U.S. Pat. No. 10,206,474, which is included in the present patent application with regard to the conformation of the electric coils and the reciprocal arrangement thereof.

At least one transmission surface area 16 is provided in preset position on the inner surface of the compartment 11; the transmission surface area 16 is adapted to interact with, i.e. to face, a given portion 46 of the helmet when this latter is housed in the compartment. The wireless power transmitter 12 is provided in this transmission surface area 16.

The transmission surface area 16 is defined, for example, on the surface of the bottom wall of the compartment. Obviously, in other embodiments the area 16 may be defined on the side wall of the compartment.

Fr example, the transmitter 12 may be arranged directly on the inner surface of the compartment, to define the transmission area, or it may be arranged below this surface, for instance in a niche provided in the thickness of the compartment wall. In these cases, the transmitter 12 may be fastened, for example, directly to the surface (as shown in FIG. 3), or arranged in the niche (as shown in FIG. 4), or even arranged in a complementary pocket opened towards the compartment and defined on the wall of the same compartment (as shown in FIG. 5).

The transmission area containing the transmitter 12 has preferably concave shape, essentially matching the convex shape of the helmet portion containing the wireless power receiver 44 of the electric device 41. When the helmet is housed in the compartment 11, the transmission area is as close as possible to the helmet portion 46 containing the receiver 44, thus optimizing the transmission capability. In some embodiments, the transmission surface area 16 is shaped so as to match the helmet portion 46 containing the wireless power receiver 44, so that the area and the portion are in contact with each another.

Given the shape of the transmission area 16, it is clearly apparent that in some configurations, for example that of the illustrated example, the transmitter may have concave shape so as to adapt to, or define, the transmission surface area 16. It is clearly apparent that, in other examples, the transmitter may be flat or substantially flat, or it may have a different shape.

Therefore, based on the various configurations, when the helmet is housed in the compartment, the portion 46 thereof is in contact with, or very close to, the transmission surface area.

It is clearly apparent that the container 10 may provide for a wireless power transmitter 12 arranged in a position other than the bottom wall of the compartment; it can be arranged, for example, on the top of the compartment 11 defined by the lid under the seat 51 (transmitter 12′), or on the side wall of the compartment (transmitter 12″). Therefore, one or more wireless power transmitters can be provided, according to the needs.

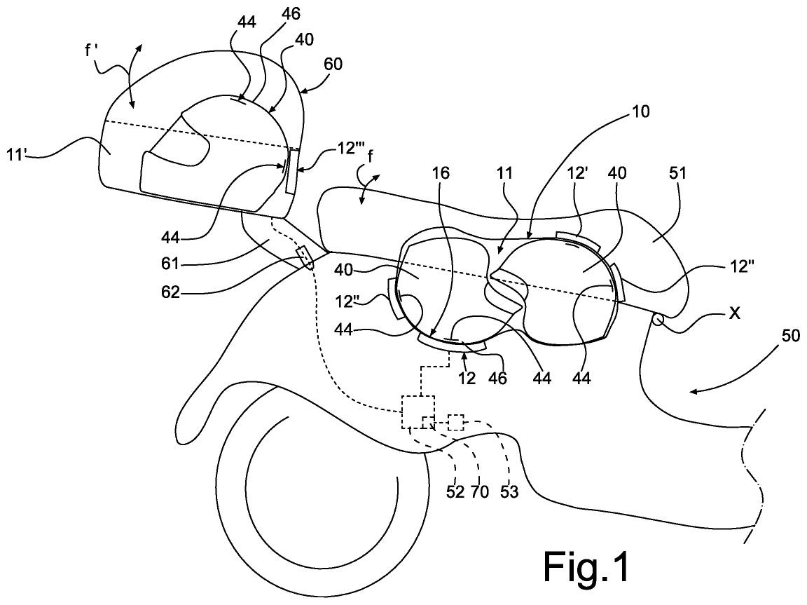

Adequately, as shown in FIG. 1, the container of the invention may be defined by a top box 60, and therefore it comprises an apparatus 61, of the known type, for instance a bracket system, for releasable fastening to a motorcycle, and a power connection device 62 adapted to connect electrically the transmitter, indicated in this example with number 12′, with the motorcycle electric system 52 and in particular with the battery 53 thereof, such as a plug operatively connected to the power transmitter 12′ and adapted to couple to a complementary plug of an electric cable operatively connected to the electric system.

What described for the under-seat container also applies to the case of a container defined by the top box 60. It provided for a compartment 11′ closed at the top by means of a lid (that can be opened according to the direction f′). The transmitter 12′″ is for example provided on the bottom wall, or on the side wall of the compartment, or on the lid. The transmitter can be like that of the previous example, arranged on the side wall of the compartment.

Advantageously, the motorcycle electric system 52 comprises an electronic control apparatus 70 provided with a control over the state of charge of the battery 42 of the helmet electric device that shall be recharged through the wireless recharge system described above, and an interface adapted to communicate the operator the charge level of the battery.

Adequately, the electronic control apparatus 70 may be provided with a control over the state of charge of the battery 53 of the motorcycle 50 and with a system for stopping the recharge of the battery 42 of the helmet electric device if the battery charge level is lower than a given threshold value, so as to prevent the running down of the motorcycle battery, avoiding the operation or actuation thereof. The electronic control apparatus 70 is also adapted to discriminate which coil 15 of the transmitter 12 is more aligned with the coil of the receiver associated with the helmet, so as to bring the current to this coil, thus maximizing the power transmission.

The electronic control apparatus 70 may also comprise a sensor 70A adapted to discriminate whether the motorcycle is off or on. More in particular, if the sensor 70A detects that the motorcycle is on, the electronic control apparatus 70 allows supplying the transmitter 12 with electric current so as to allow recharging the battery 42 (or other equipment) of the helmet. Conversely, if the sensor 70A detects that the motorcycle is off, the electronic apparatus 70 allows supplying the transmitter 12 with electric current only if the charge level of the battery 53 is equal to, or greater than, a given threshold value.

The container 10 may provide for positioning means adapted to keep the helmet 40 adequately positioned inside the container, so that the transmission area in the compartment and the helmet area provided with the wireless power receiver are adequately close to, or in contact with, each other, to optimize the power transmission. These positioning means may comprise, for example, an abutment in the compartment forcing the helmet to take a given direction and position, thus ensuring the right closeness thereof to (or contact thereof with) the transmission area.

The positioning means may even comprise simple visual indicators provided both in the compartment (for example visual indicators indicating the transmission area) and on the helmet (visual indicators indicating the position of the power receiver), so as to indicate to the user where to position the helmet in the compartment, for example by positioning the two visual indicators (of the transmission area and of the receiver) near each other.

According to an embodiment not shown in the figures, the container may comprise a device for coupling and/or fastening the wireless power transmitter to the helmet shell. In this way, the transmitter and the receiver associated with the helmet may be mutually coupled or fastened in a position optimal for power transmission, without the risk of mutual accidental displacements. The coupling and/or fastening device provides for a reciprocal coupling and/or fastening of the transmitter and the helmet of the magnetic attraction type. For example, one or more permanent magnets are provided in correspondence of the transmitter, for example three magnets not aligned with one another, and three respective ferromagnetic bodies are provided inside the shell of the helmet (or vice versa), mutually arranged in the same way as the permanent magnets, so that, when the helmet is in the compartment, the permanent magnets are coupled to the ferromagnetic bodies and the transmitter is fastened to the helmet, preferably centered in optimal manner on the helmet receiver.

With reference to the device for coupling and/or fastening the transmitter to the helmet shell, in an embodiment the transmitter may be associated in non-rigid manner to the wall (side wall, bottom wall or lid), i.e. it may be not rigidly integrated into the wall of the compartment. In this configuration, while the motorcycle moves, in case of significant accidental displacement of the helmet relative to the compartment walls, the transmitter is able to follow at least partially the movement of the helmet.

As regards the helmet 40 (see FIG. 2), it has the typical structure of a known helmet, and it comprises, in particular, an outer shell 40A and an inner protection padding 40B for the motorcyclist's head. As mentioned above, the helmet is provided with an electrically powered service device 41 powered by a rechargeable electric battery 42.

The form and shape of the helmet of the invention may be the most varied.

For example, in FIG. 1 two open-face helmets are arranged in the under-seat compartment, whilst a full-face helmet is arranged in the top box.

The helmet comprises a wireless power recharge module 43 for recharging the rechargeable battery 42, including a recharging circuit 43A and the wireless power receiver 44 adapted to receive power from the wireless power transmitter 12 of the container 11 where the helmet is housed during the recharge step.

The receiver 44 is adapted to receive power in a manner coherent to the power transmission from the transmitter 12.

Therefore, the receiver 44 is, in this example, of inductive coupling type, especially of resonant type, and comprises an electric coil 45 adapted to receive a magnetic field generated by the transmitter 12. The magnetic field generated by the transmitter 12 induces an induced electric current in the electric coil 45 of the receiver 44.

The receiver 44 is provided in a given position in the helmet, for example in the upper area 49 of the helmet, adapted to couple optimally the receiver 44 to the transmitter 12 of the container 11 where the helmet is housed.

The receiver 44 is preferably arranged in the concave space defined by the shell 40A and, more in particular, it is preferably arranged between the inner shell and the protection padding 40B, close to, or in contact with, the inner face of the shell 40A. Advantageously, the electric coil 45 of the receiver 44 is planar, and preferably integrated into the shell 40A of the helmet. The electric coil 45 of the receiver 44 is structurally and functionally similar to that or those of the transmitter 12; therefore, for further technical details reference should be made to the corresponding part of the description.

For safety reasons, the larger parts of the electric/electronic components associated with the helmet are arranged in a lower area 47 of the helmet (the area having the end edge 48 delimiting the area where the motorcyclist's head enters), so that, in case of significant impact, these parts do not moves towards the motorcyclist's cranium.

This lower area 47 is preferably defined, for example, by a 10 cm high band extending from the lower end edge 48 upwards.

The receiver 44 has reduced dimensions; it can be therefore housed in the upper area 49 of the helmet, i.e. an area outside the above mentioned band forming the lower area 47.

Adequately, the rechargeable battery 42 is arranged in the lower area 47, as well any other part of the wireless recharge module 43 and of the service device 41.

The receiver 44 is for example wired up to the part of wireless recharge module 43 provided in the lower area 47.

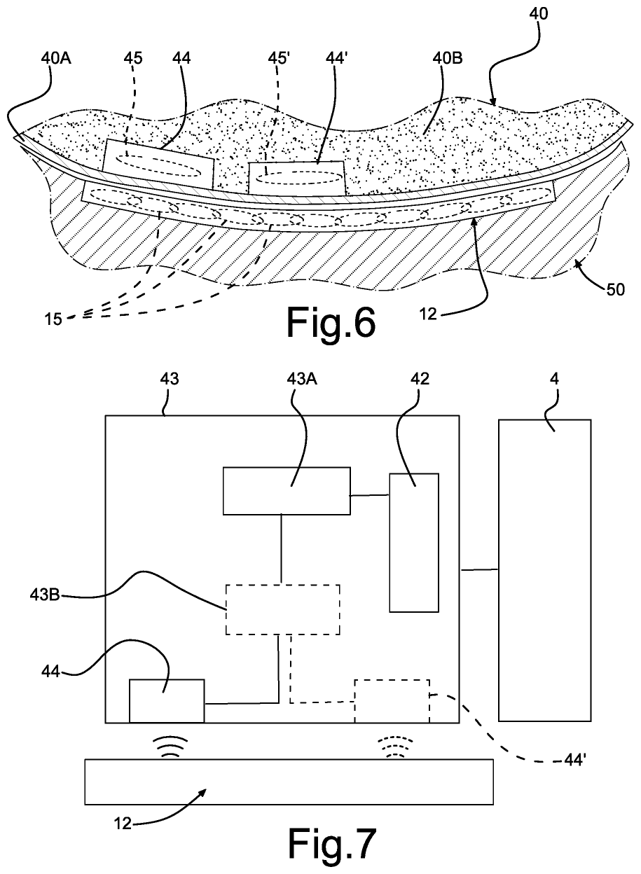

The module 43 may also comprise a second wireless power receiver 44′ (or more second wireless power receivers 44′), arranged near the first wireless power receiver 44. In this way, the module 43 is adapted to detect which of the two receivers 44 and 44′ is receiving power less efficiently than the other; the module further comprises a switching device 43B (see the diagram of FIG. 7, where the supplementary receiver 44′ and the switching device are shown in broken line, to indicate the shell of a module 43 with more than one receiver) adapted to disable, during a recharge step, the receiver that is receiving power less efficiently than the other receiver, analogously to what described for the receivers disclosed in the above mentioned patent U.S. Pat. No. 10,206,474.

The electrically powered service device 41 provided in the helmet 40 may comprise one or more of the following apparatuses. intercom, headphones, microphone, interface with mobile communication device, apparatus for sending to a remote entity a notice if the motorcyclist falls, vocal apparatus for controlling one or more functions of the motorcycle.

The transmitter 12 is also adapted to recharge rider's mobile devices. For instance, by putting a mobile phone, adapted to be recharged through induction (of a type compatible with the recharge system used for the helmet), on the bottom of the under-seat compartment in correspondence of the transmission area 16 during an active recharge step, the recharge circuit of the mobile phone receives induced electric power so as to recharge at least partially the battery thereof.

From an operational viewpoint, the user may arrange the helmet in the under-seat compartment or in the top box, paying attention to arrange it so that the part of the helmet containing one or more receivers 44 is arranged in correspondence of (in contact with, or close to) the transmission area 16.

If the sensor 70A detects that the motorcycle is on, the power transmission takes place.

If the sensor 70A detects that the motorcycle is off (not running), in case the battery powering the motorcycle is sufficiently charged, the power transmission may take place. Conversely, if the battery powering the motorcycle is not sufficiently charged, the power transmission does not take place.

The recharge system allows power transmission until the battery of the electric device associated with the helmet has been recharged. If the charge level of the battery of the motorcycle electric system is too low, the recharge system stops the power transmission, to ensure the good operation of the motorcycle.

It is understood that what is illustrated purely represents possible non-limiting embodiments of the invention, which may vary in forms and arrangements without departing from the scope of the concept on which the invention is based. Any reference numerals in the appended claims are provided for the sole purpose of facilitating the reading thereof in the light of the description above and the accompanying drawings and do not in any way limit the scope of protection.

1. A motorcycle comprising
a container for housing a motorcycle helmet, defining a compartment where the helmet can be arranged, said container further comprising at least one wireless power transmitter, associated with said compartment, that can be operatively connected to a power source and that is adapted to send electric charge to at least one wireless power receiver of an electric device provided with at least one rechargeable battery associated with said helmet, to recharge said battery during a step of wireless power recharge,
an electric system that is, or can be, operatively connected to said at least one wireless power transmitter of said container, said electric system being provided with a battery of the motorcycle and with an electronic control apparatus provided with the following controls:
control over the state of charge of said at least one battery of said at least one electric device of said helmet,
control over the state of charge of the motorcycle battery and stop of the charge of the battery of the helmet electric device if the charge level of the motorcycle battery is lower than a threshold value.

2. The motorcycle of claim 1, wherein said electronic control apparatus comprises a communication interface adapted to communicate to the operator the charge level of said at least one battery of said at least one electric device of said helmet.

3. The motorcycle of claim 1, wherein said electronic apparatus comprises a sensor adapted to discriminate whether the motorcycle is on or off,
wherein, if said sensor detects that said motorcycle is on, said electronic control apparatus is adapted to supply said transmitter with electric current,
wherein, if said sensor detects that the motorcycle is off, said electronic control apparatus is adapted to supply said transmitter with electric current if the charge level of the motorcycle battery is greater than a given threshold value.

4. The motorcycle of claim 1, wherein said at least one wireless power transmitter is of inductive coupling type, preferably of resonant type.

5. The motorcycle of claim 1, wherein said at least one wireless power transmitter comprises at least one electric coil, preferably planar and flat-shaped or curve-shaped, adapted to induce electric current.

6. The motorcycle of claim 1, wherein said at least one wireless power transmitter comprises a plurality of electric coils, preferably planar, flat-shaped or concave-shaped, arranged near one another or put partially over one another according to a predefined scheme.

7. The motorcycle of claim 6, wherein said electronic control apparatus is adapted to discriminate which coil of said wireless power transmitter is more aligned with a coil of said wireless power receiver associated with the helmet, so as to bring the current to said coil, thus maximizing the power transmission.

8. The motorcycle of claim 1, comprising, on the inner surface defining said compartment, at least one surface area for electric charge transmission, said at least one wireless power transmitter being provided in said at least one surface transmission area, so that, considering a helmet that comprises at least one said electric device to be recharged and that is provided with said at least one wireless power receiver arranged in a given portion of the helmet, when said helmet is housed in said compartment, said at least one wireless power transmitter faces said at least one wireless power receiver so as to allow the power transmission, preferably so that said transmitter and said receiver are axially aligned with each other.

9. The motorcycle of claim 8, wherein said at least one surface area is concave so as to follow, when said helmet is housed in said compartment, the convexity of said given portion of helmet provided with said at least one wireless power receiver, said given portion being in contact with, or very close to, said surface area when the helmet is housed in said compartment.

10. The motorcycle of claim 1, wherein said at least one wireless power transmitter is provided on one or more of the following: a lid of said compartment, the bottom of said compartment, a side wall of said compartment.

11. The motorcycle of claim 1, characterized in that said container is in the form of a top box, and comprises a reversible fastening apparatus for fastening to a motorcycle, a power connection device adapted to connect electrically said at least one wireless power transmitter to the electric system of the motorcycle.

12. The motorcycle of claim 1, wherein said compartment is integrated into the motorcycle, so that a seat of the motorcycle forms an openable lid of the compartment, and wherein said at least one wireless power transmitter is operatively connected to the electric system of the motorcycle.

13. The motorcycle of claim 12, wherein said at least one wireless power transmitter is arranged in said compartment and/or in the seat of the motorcycle.

14. The motorcycle of claim 1, wherein said container comprises a device for coupling and/or fastening the at least one wireless power transmitter to the helmet shell, so that the at least one wireless power transmitter and the at least one wireless power receiver associated with the helmet are coupled and/or fastened to each other in the mutual position optimal for power transmission.

15. The motorcycle of claim 14, wherein said coupling and/or fastening device provides for a reciprocal coupling and/or fastening of the transmitter and the helmet of the magnetic attraction type.

16. The motorcycle of claim 14, wherein the at least one wireless power transmitter is associated in non-rigid manner with the wall of said compartment of the container, so that, while the motorcycle moves, in shell the helmet accidentally moves away from the wall, the transmitter is adapted to follow the helmet, avoiding the release thereof

17. A motorcycle helmet according to claim 1, comprising
an outer shell and a protection padding for the motorcyclist's head,
at least one electrically powered service device powered by at least one rechargeable battery,
a wireless recharge module for electrically recharging said at least one rechargeable battery, said recharge module comprising at least one wireless power receiver adapted to receive electric power from a wireless power transmitter during a power recharge step.

18. The helmet of claim 17, wherein said at least one wireless power receiver comprises at least one electric coil, preferably planar and flat-shaped or convex-shaped, arranged near the shell or integrated thereinto.

19. A method for recharging an electric device associated with a helmet for motorcycles provided with an electric battery, providing for the following steps:
inserting the helmet inside a container defined in the under-seat compartment of a motorcycle or in a top box fastened to a motorcycle, and
transmitting electric power, through induction, from a wireless power transmitter provided in said container to at least one wireless power receiver provided on said helmet , which is operatively connected to an electric battery, allowing the recharge thereof, and wherein, before said power transmission step, verifying the charge level of said at least one battery of said at least one electric device of the helmet and verifying the charge level of the battery of the motorcycle and, if the charge level of the battery of the motorcycle is below a given threshold level, stopping the electric power transmission from said transmitter to said receiver of the battery of the electric device of the helmet.

20. The method of claim 19, providing for verifying, preferably through a sensor, whether the motorcycle is off or on and, in case the motorcycle is on, supplying electric current from the battery of the motorcycle to the wireless power transmitter for recharging.

21. The method of claim 19, providing for verifying, preferably through a sensor, whether the motorcycle is off or on and, in case the motorcycle is off, supplying electric current from the battery of the motorcycle to the wireless power transmitter only when the charge level of the motorcycle battery is greater than a given threshold value.
